(19) United States
(12) Patent Application Publication
(10) Pub. No.: US 2026/0223021 A1
(43) Pub. Date: Jul. 30, 2026

(54) Synchronization Reference Path Selection in Cellular Network for Bi/Multi-Static Radar Operation

(71) Applicant: Telefonaktiebolaget LM Ericsson (publ), Stockholm (SE)

(72) Inventors: Magnus Sandgren, Staffanstorp (SE); Robert Baldemair, Solna (SE); Athanasios Stavridis, Malmö (SE); Håkan Björkegren, Täby (SE)

(21) Appl. No.: 19/120,124

(22) PCT Filed: Nov. 30, 2023
(86) PCT No.: PCT/IB2023/062095

§ 371 Date: Apr. 10, 2025

(30) Foreign Application Priority Data
Dec. 2, 2022 (GR) 20220101001

(51) Int. Cl. H04W 56/00; H04W 24/08

(52) U.S. Cl. CPC H04W 56/0015; H04W 24/08

(57) ABSTRACT

A method, network node and wireless device (WD) for synchronization reference path selection in a cellular network for bistatic and multi-static radar operation are disclosed. According to one aspect, a method in a WD or radio base station includes selecting a first synchronization reference path for synchronization between a first network node and a second network node via a first reconfigurable repeater, the first synchronization reference path being resolvable from a second synchronization path that includes a second reconfigurable repeater, the first synchronization reference path being selected to be resolvable from an object. The method also includes, in an event of interference or jamming in the first synchronization reference path, using the second synchronization reference path via the second reconfigurable reference path for synchronization between the first network node and the second network node.

### TECHNICAL FIELD

The present disclosure relates to wireless communications, and in particular, to synchronization reference path selection in a cellular network for bistatic and multi-static radar operation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

Joint Communication and Sensing (JCAS) is an emerging research area which is already standardized in the Institute of Electrical and Electronics Engineers (IEEE) standard, IEEE 802.11, discussed in 3GPP, and anticipated as a basic ingredient element in 6G. Sensing in a JCAS system may be done in radar or using Channel State Information (CSI). In radar, one or more pulses are transmitted for the purpose of range and Doppler measurements. Even though the use of radar in Line-of-Sight (LoS) propagation environments is very effective, its deployment in environments with strong Non Line-of-Sight (NLOS) characteristics becomes challenging. In contrast, CSI-based sensing has the potential to overcome some of these limitations by undertaking measurements of the CSI of the underlying channel between a transmitter and a receiver. In this approach, inferences regarding the presence of an object (which is not necessarily a device) and/or any other quantity of interest is done through the change of CSI at different time instances or with the appropriate processing of the CSI of one instance. In literature, this form of sensing is called Device-Free-Sensing (DFS). Here, the word “free” is connected with the fact that the object is not necessarily a device, and it is just present in the physical space of interest.

Conceptually, the simplest form of sensing is monostatic sensing. Monostatic sensing is identified as the case where both the TX and RX are placed in the same physical position and operate in Full Duplex (FD) mode. Due to technical challenges and complexity of a FD node in monostatic sensing, bi-static sensing has been considered as an alternative option. In bistatic sensing, the TX and RX are geographically separated while operating in the same radio-temporal resources. A further extension is multi-static sensing where multiple geographically separated transmitters are transmitting signals which are perceived by multiple geographically separated receivers.

The focus of this disclosure is on bistatic sensing and its extension to multi-static sensing. The operating principle of bistatic sensing is illustrated in FIG. 1. As shown in the example of FIG. 1, there is a transmit node (TX) and a receiving node (RX). The TX emits sensing signals which, after their propagation in the existing environment, are collected from the receiver. Assuming that there is only one object and provided that the TX and the RX are synchronized in time, the RX is able to measure the Time of Flight (ToF) at the output of a matched filter. From the ToF (T_{object}), the bistatic range (D_{tot-object}) is obtained. The bistatic range is the distance between the TX and the object (D_{TX-object}) plus the distance between the object and the RX (D_{object-RX}). In literature, it is well known that, in the absence of knowledge of the Angle of Departure (AoD) in the TX and the Angle of Arrival (AoA) in the RX, from the bistatic range it may be concluded that the object is placed somewhere on the surface of an ellipsoid with focal points in the TX and RX. In contrast if the AoD and/or the AoA are available, the exact or more accurate knowledge of the position of the object on the ellipse may be extracted. In both cases, it is assumed that the distance between the TX and RX is known.

The efficient operation of bistatic sensing relies on the time synchronization between the TX and RX. Achieving accurate synchronization between physically separated TX and RX nodes is a key challenge compared to mono static radars where the transmitter and receiver share a common clock source and common time close to the radio unit and its antenna reference point.

Time synchronization would be needed to accurately determine T_{object} and for determining D_{tot-object}, i.e., the receiver would need to accurately relate a reflection reception time (T_{rx_object}) with the transmission time at the TX node (Tₜₓ). A time error between transmitter and receiver of only 3 ns would approximately correspond to a 1 m range inaccuracy.

Radio frequency (RF) carrier phase synchronization is needed to detect object mobility and estimate its velocity by detecting RF carrier phase changes in the reflected path. A relative RF frequency error of 3 ppb between the TX and RX nodes at 3.5 GHz would correspond to a frequency difference of approximately 10 Hz which then would then be similar to a Doppler shift by a pedestrian and hence would limit the lowest possible speed that may be safely detected. Worth noting is that the 3GPP-required base station frequency accuracy for communication is ±50 ppb, i.e., a relative difference of 100 ppb between TX and RX node.

Different means to synchronize physically separated base stations exists, e.g., having individual local global navigation satellite system (GNSS) synchronization receivers, a common timing source like a GNSS synchronization receiver with Precision Time Protocol (PTP) and/or SyncE to distribute time and frequency towards the nodes. The distribution path generally involves multiple nodes and components, each contributing to total errors all the way up to the antenna reference point. Therefore, achieving very strict inter-node synchronization is challenging and complex considering the required wired infrastructure that needs to be installed. Improved frequency accuracy and stability of local oscillators beyond what is needed for communication comes with additional cost. Global navigation satellite system (GNSS) synchronization receivers will require installations allowing free view of the sky, which is not always possible or requires expensive installations. In addition, jamming of GNSS receivers is a well-acknowledged problem.

Using over the air synchronization in various forms and especially using a direct synchronization between the TX and RX is likely the most promising method to achieve accurate and cost-efficient synchronization for bi and multi static radars. For the direct synchronization, the transmitted sensing signal from the TX node are used both for the sensing of objects and synchronization at the receiver. The synchronization path may be either Line-Of-Sight (LOS) or a controlled (well characterized) Non-Line-Of-Sight (NLOS) path. Such approach would also benefit from canceling out errors or changes in the TX/RX nodes which are common for the reflected path and the synchronization path, e.g., errors/changes within the radio TX and RX chains like delay or phase changes.

As shown in the example of FIG. 2, in the presence of a strong LoS synchronization reference path between the TX and RX in a bi or multi static radar deployment, the receiver is exposed to signals that have propagated through the LOS and through reflections created from objects in the environment. Clearly, objects with reflections arriving (T_{rx_object}) at or close in time to a strong LOS reference path (T_{rx_ref}) may be difficult to distinguish from the direct path, since bandwidth and thereby resolution in the receiver will be limited. Avoiding this would be difficult in a bistatic radar setup since objects close to the LOS paths still needs to be illuminated to be detected through reflections. A multi static radar approach with multiple TX-RX pairs may complement each other i.e.; one set of TX-RX pair may cover objects appearing in the LOS direction between another TX-RX pair.

In certain scenarios, the use of a well-characterized and stable NLOS synchronization reference path as shown in FIG. 3 would be an alternative to a LOS synchronization path, e.g., in certain deployment there might not even be a LOS path available between the TX and RX nodes. Another advantage would be that the receiver would not experience large signal dynamics between a strong LOS path and a weaker reflection. The NLOS reference path would have the same issues as a LOS synchronization path, i.e., it may be difficult to separate reflections from objects close to the NLOS synchronization path and hence, arriving at the same time or close in time from it. Beamforming capability in the receiving node may separate reflections arriving at the same time in the spatial domain (like for object B in FIG. 3) but beamforming resolution is also limited. Hence, objects at or close to the NLOS reflection point (object A) may not be distinguishable.

Another problem is the availability and criticality of the synchronization reference path. The bi-multi static sensing functionality may be used for critical infrastructure like monitoring a traffic cross section. The synchronization reference path may be blocked or interfered (undeliberate or deliberately jammed) and hence, a robust solution is required. Like the issue above, i.e., to detect and distinguish objects close to the synchronization reference path's NLOS reflection point, reflections from such objects may also impact the receiver's ability to distinguish and accurately resolve the synchronization reference. This creates an uncertainty in reception time and thereby degrades the radar sensing.

### SUMMARY

Some embodiments advantageously provide methods, network nodes and WDs for synchronization reference path selection in a cellular network for bistatic and multi-static radar operation.

Some embodiments employ reconfigurable repeaters such as Reconfigurable Intelligent Surfaces (RIS) for the synchronization paths.

Some embodiments solve the close-in object problem by configuring the RIS to detect or track objects close to the RIS, and to change the characteristics of the synchronization reference, by at least one or more of:
Changing or disabling the reflected synchronization reference path to the bistatic receiver and enable an alternative synchronization path, e.g., by using another RIS or redirecting the path through another reflector in the environment; and
Change the delay for the synchronization path through the RIS with a known and accurate amount.

Some embodiments use Reconfigurable Intelligent Surfaces (RIS) to increase the robustness and/or performance of the synchronization path either by selecting an alternative second RIS or changing the path through a first RIS where the receiver monitors the quality of the synchronization paths and may be based on conditions to select a best available path.

In some embodiments, an object-reflected sensing path is detected in a bi/multi static radar scenario having a resolution degradation or over-the-air synchronization reference path synchronization degradation. The degradations are due to channel similarities and close arrival times for the sensing and synchronization paths related to receiver resolution limitation.

In some embodiments, Reconfigurable Intelligent Surfaces (RIS) are provided to mitigate limitations by configuring and using alternative synchronization paths dependent on relative position for object and RIS.

In addition, RIS may be used to increase the robustness and performance of the synchronization path. The receiver may, on a regular basis, monitor the quality of different reference path alternatives created by the RIS and select the most appropriate alternative. Monitoring may include checking relative arrival times between different paths and thereby detect a spoofing attempt to manipulate the arrival time of one of the synchronization paths.

According to one aspect, a first network node configured to communicate with a second network node is provided. The first network node is configured to use a first synchronization reference path for synchronization between the network node and the WD via a first reconfigurable repeater, the first synchronization reference path being resolvable from a second synchronization path that includes a second reconfigurable repeater, the first synchronization reference path being selected to be resolvable from an object. The first network node is also configured to, in an event of interference or jamming in the first synchronization reference path, use the second synchronization reference path via the second reconfigurable reference path for synchronization between the first network node and the second network node.

According to this aspect, in some embodiments, the first network node is configured to track an object using the first synchronization reference path. In some embodiments, switching between the first and second synchronization reference paths occurs according to a pattern based at least in part on an allowable delay for detecting an object during a radar scan. In some embodiments, one of the first and second synchronization reference path is selected based at least in part on at least one of a time of arrival (ToA) and a time of flight (ToF). In some embodiments, a decision to switch between the first and second synchronization reference paths is based at least in part on a prediction of a future position of an object. In some embodiments, the first network node is configured to monitor multiple synchronization reference paths and select a reference path based at least in part on resolvability of the object for each synchronization reference path. In some embodiments, the first network node is further configured to monitor arrival times for each of the first and second synchronization reference paths to defeat spoofing. In some embodiments, at least one of the first synchronization reference path and the second synchronization reference path includes a passive reflector. In some embodiments, using the second synchronization reference path includes changing a reference path angle or delay for the second synchronization reference path. In some embodiments, the first network node is one of a WD and a radio base station and the second network node is one of a WD and a radio base station.

According to another aspect, a method implemented in a first network node configured to communicate with a wireless device, WD, is provided. The method includes selecting a first synchronization reference path for synchronization between the first network node and the second network node via a first reconfigurable repeater, the first synchronization reference path being resolvable from a second synchronization path that includes a second reconfigurable repeater, the first synchronization reference path being selected to be resolvable from an object. The method includes, in an event of interference or jamming in the first synchronization reference path, using the second synchronization reference path via the second reconfigurable reference path for synchronization between the first network node and the second network node.

According to this aspect, in some embodiments, the method includes tracking an object using the first synchronization reference path. In some embodiments, switching between the first and second synchronization reference paths occurs according to a pattern based at least in part on an allowable delay for detecting an object during a radar scan. In some embodiments, one of the first and second synchronization reference path is selected based at least in part on at least one of a time of arrival, ToA, and a time of flight, ToF. In some embodiments, a decision to switch between the first and second synchronization reference paths is based at least in part on a prediction of a future position of an object. In some embodiments, the method includes monitoring multiple synchronization reference paths and select a reference path based at least in part on resolvability of the object for each synchronization reference path. In some embodiments, the method includes monitoring arrival times for each of the first and second synchronization reference paths to defeat spoofing. In some embodiments, at least one of the first synchronization reference path and the second synchronization reference path includes a passive reflector. In some embodiments, using the second synchronization reference path includes changing a reference path angle or delay for the second synchronization reference path. In some embodiments, the first network node is one of a WD and a radio base station and the second network node is one of a WD and a radio base station.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of bi-static sensing;

FIG. 2 illustrates a near line of sight obstacle and a line of sight reference path;

FIG. 3 illustrates an alternative path with a reflector;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node or wireless device (WD) for synchronization reference path selection in a cellular network for bistatic and multi-static radar operation;

FIG. 11 is a flowchart of another example process in a network node or wireless device (WD) for synchronization reference path selection in a cellular network for bistatic and multi-static radar operation;

FIG. 12 illustrates bi-static sensing via RIS;

FIG. 13 illustrates alternative synchronization reference paths;

FIG. 14 illustrates another set of alternative synchronization reference paths;

FIG. 15 is a flowchart of an example scanning process; and

FIG. 16 is a flowchart of an example tracking process.

### DETAILED DESCRIPTION

Before describing in detail example embodiments, it is noted that the embodiments reside primarily in combinations of apparatus components and processing steps related to synchronization reference path selection in a cellular network for bistatic and multi-static radar operation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “network node” used herein may be used to also denote a wireless device (WD) or a radio base station.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide synchronization reference path selection in a cellular network for bistatic and multi-static radar operation.

Some embodiments employ over-the-air (OTA) synchronization by using the same transmitted signal for receiver synchronization as for illumination of an area in a bi/multi static radar deployment. This has several synchronization advantages needed both for accurate ranging and mobility detection through RF carrier phase changes. With such approach, reflections from objects arriving at or close in time with the synchronization reference path may be masked and difficult to distinguish. This may result in a sensing degradation for objects present close to the reflection point for the synchronization path or cause a degradation of the synchronization.

Accurate and robust over the air synchronization for radar sensing is achieved for bi-Multi static sensing by some embodiments.

Some embodiments include methods to mitigate such sensing degradations and provide robust synchronization by use of Reconfigurable Intelligent Surfaces (RIS).

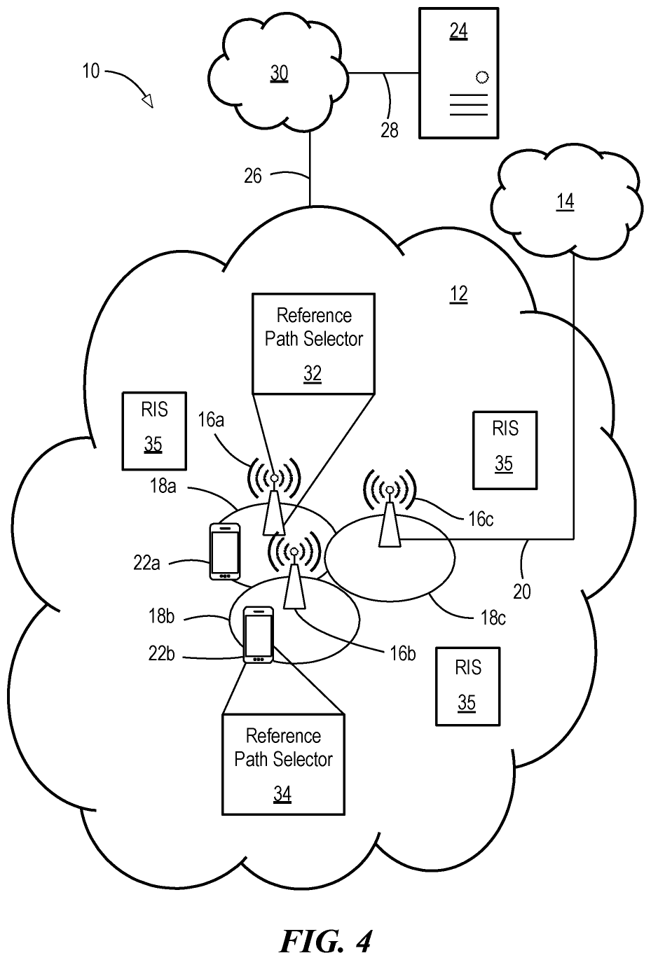

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

In some embodiments, the network node 16 and/or WD 22 may be configured for bi-static or multi-static sensing, using a reconfigurable repeater, such as RIS 35, in a synchronization reference path.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

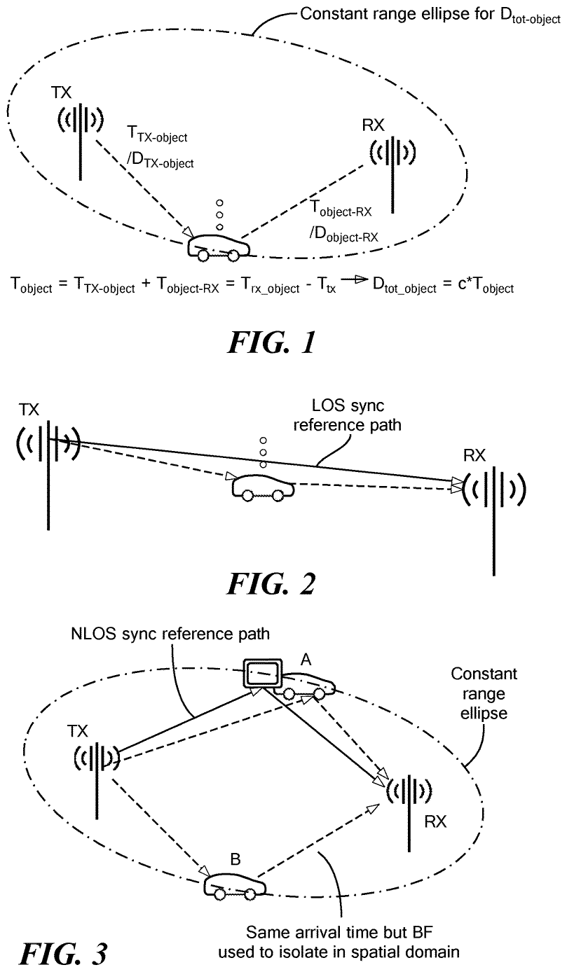

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a reference path selector 32 which is configured to use a first synchronization reference path via a first reconfigurable intelligent surface (RIS) 35 to scan for an object not resolvable in one of distance, time and angle from a location of a second RIS 35. Similarly, the WD 22 may include a reference path selector 34 which is configured to use a first synchronization reference path via a first reconfigurable intelligent surface (RIS) 35 to scan for an object not resolvable in one of distance, time and angle from a location of a second RIS 35. In some embodiments, the reference path selector 32, 34 is configured to, in an event of interference or jamming in the first synchronization reference path, use the second synchronization reference path via the second reconfigurable reference path for synchronization between the network node and the WD.

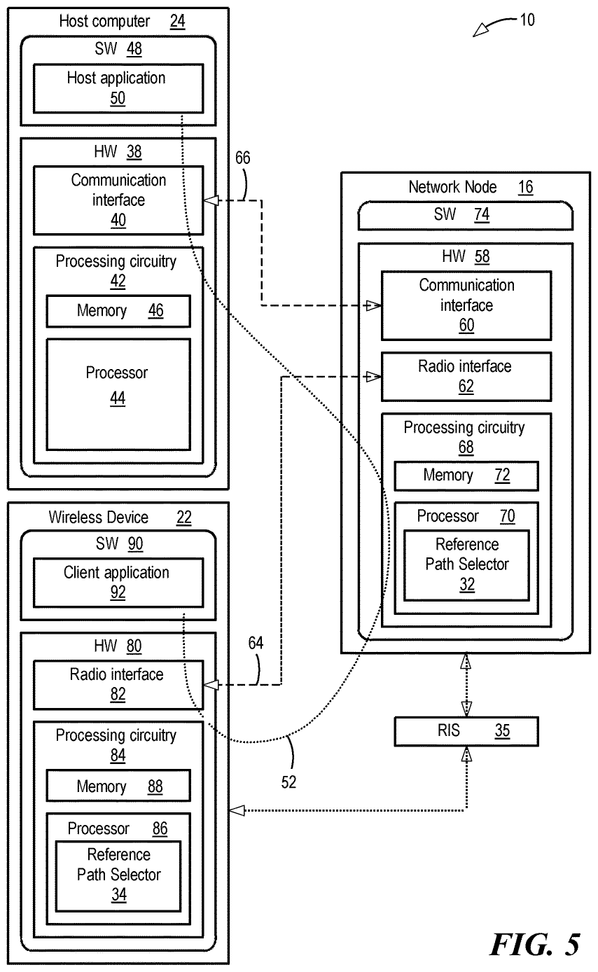

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a reference path selector 32 which is configured to use a first synchronization reference path via a first reconfigurable intelligent surface (RIS) 35 to scan for an object not resolvable in one of distance, time and angle from a location of a second RIS 35. In some embodiments, the reference path selector 32 is configured to, in an event of interference or jamming in the first synchronization reference path, use the second synchronization reference path via the second reconfigurable reference path for synchronization between the network node and the WD.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a reference path selector 34 which is configured to use a first synchronization reference path via a first reconfigurable intelligent surface (RIS) 35 to scan for an object not resolvable in one of distance, time and angle from a location of a second RIS 35. In some embodiments, the reference path selector 34 is configured to, in an event of interference or jamming in the first synchronization reference path, use the second synchronization reference path via the second reconfigurable reference path for synchronization between the network node and the WD.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both.

While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as reference path selector unit 32, and reference path selector unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

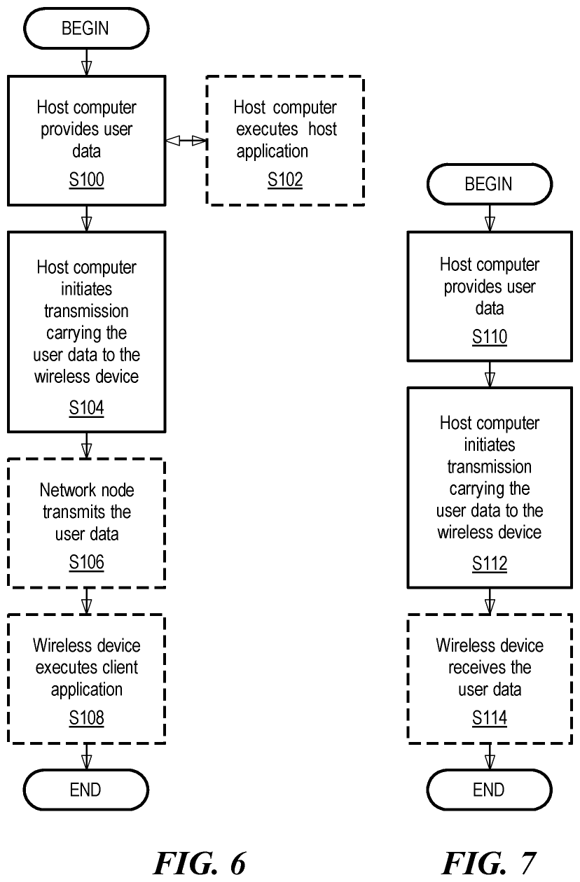

FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

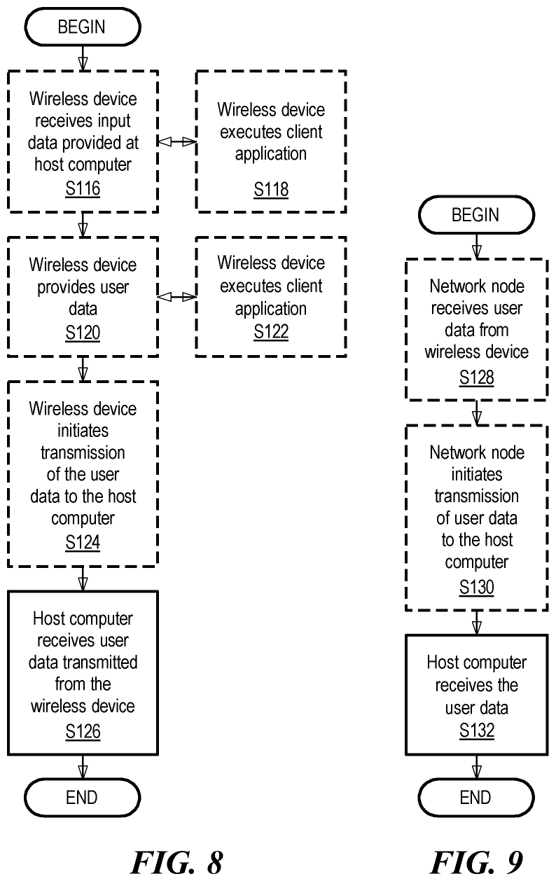

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

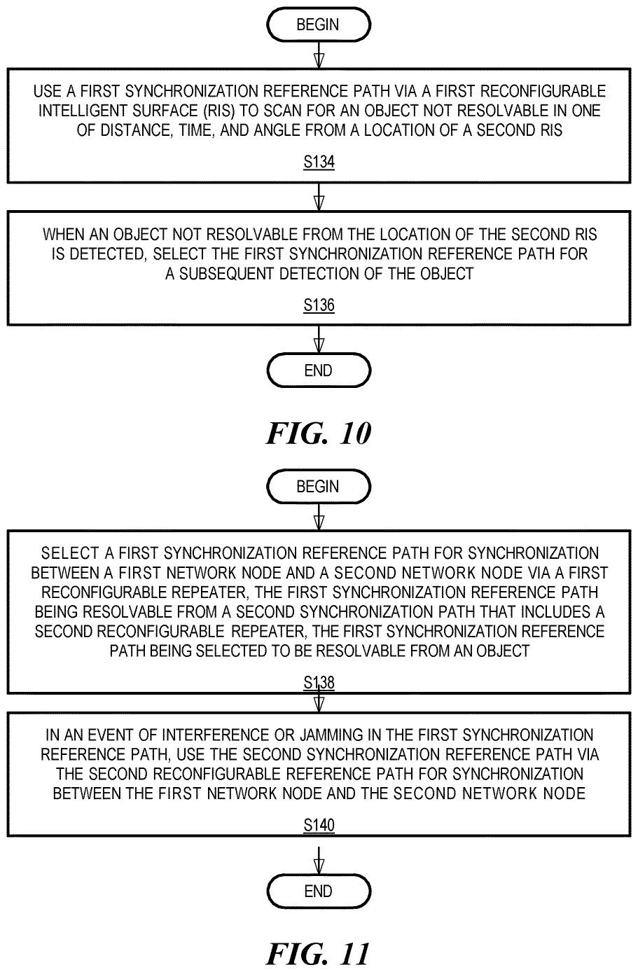

FIG. 10 is a flowchart of an example process in a network node 16 or a wireless device 22 for synchronization reference path selection in a cellular network for bistatic and multi-static radar operation. One or more blocks described herein may be performed by one or more elements of network node 16 such as by one or more of processing circuitry 68 or 84 (including the reference path selection unit 32 or 34), processor 70 or 86, radio interface 62 or 82 and/or communication interface 60. The process includes using a first synchronization reference path via a first reconfigurable intelligent surface (RIS) 35 to scan for an object not resolvable in one of distance, time and angle from a location of a second RIS 35 (Block S134). The process includes, when an object not resolvable from the location of the second RIS 35 is detected, selecting the first synchronization reference path for a subsequent detection of the object (Block S136). In some embodiments, the method also includes tracking the object using the first synchronization reference path. In some embodiments, the method includes switching between the first synchronization reference path via the first RIS 35 and a second synchronization reference path via a second RIS 35. In some embodiments, the switching occurs according to a pattern based at least in part on an allowable delay for detecting an object during a radar scan. In some embodiments, the second synchronization path is selected based at least in part on at least one of a time of arrival (ToA) and a time of flight (ToF). In some embodiments, a decision to switch between the first and second synchronization reference path is based at least in part on a prediction of a future position of the object. In some embodiments, the method includes monitoring multiple synchronization reference paths and selecting a reference path based on resolvability of the object for each synchronization reference path. In some embodiments, the method also includes monitoring arrival times for each a plurality of synchronization reference paths to defeat spoofing. In some embodiments, the method includes ensuring that objects close to the RIS do not impact the synchronization path by causing sync path resolution degradation. In some embodiments, the method includes selecting a reference path which does not have synchronization resolution degradation due to nearby objects.

FIG. 11 is a flowchart of another example process in a first network node 16, 22 and a second network node 16, 22 for synchronization reference path selection in a cellular network for bistatic and multi-static radar operation. One or more blocks described herein may be performed by one or more elements of network node 16 or wireless device 22, such as by one or more of processing circuitry 68 or 84 (including the reference path selection unit 32 or 34), processor 70 or 86, radio interface 62 or 82 and/or communication interface 60. The process includes selecting a first synchronization reference path for synchronization between the first network node 16, 22 and the second network node 16, 22 via a first reconfigurable repeater, the first synchronization reference path being resolvable from a second synchronization path that includes a second reconfigurable repeater, the first synchronization reference path being selected to be resolvable from an object (Block S138). The method includes, in an event of interference or jamming in the first synchronization reference path, using the second synchronization reference path via the second reconfigurable reference path for synchronization between the first network node and the second network node (Block S140).

According to this aspect, in some embodiments, the method includes tracking an object using the first synchronization reference path. In some embodiments, switching between the first and second synchronization reference paths occurs according to a pattern based at least in part on an allowable delay for detecting an object during a radar scan. In some embodiments, one of the first and second synchronization reference path is selected based at least in part on at least one of a time of arrival, ToA, and a time of flight, ToF. In some embodiments, a decision to switch between the first and second synchronization reference path is based at least in part on a prediction of a future position of an object. In some embodiments, the method includes monitoring multiple synchronization reference paths and select a reference path based at least in part on resolvability of the object for each synchronization reference path. In some embodiments, the method includes monitoring arrival times for each of the first and second synchronization reference paths to defeat spoofing. In some embodiments, at least one of the first synchronization reference path and the second synchronization reference path includes a passive reflector. In some embodiments, using the second synchronization reference path includes changing a reference path angle or delay for the second synchronization reference path. In some embodiments, the first network node is one of a WD and a radio base station and the second network node is one of a WD and a radio base station.

Having described the general process flow of arrangements of the disclosure and having provided examples of hardware and software arrangements for implementing the processes and functions of the disclosure, the sections below provide details and examples of arrangements for synchronization reference path selection in a cellular network for bistatic and multi-static radar operation.

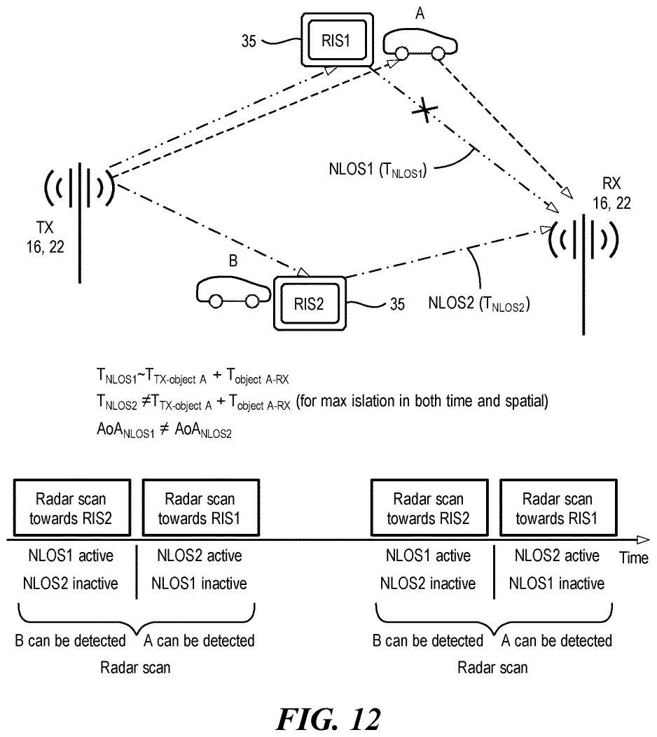

A NLOS synchronization reference path may be created from already existing static objects in the environment if they have a stable and well characterized channel (e.g., through TX and RX node Round Trip Time (RTT) measurements) or it may be artificially created by placing reflectors at a known and suitable location within the area. The direction and ToF (T_{ref_path}) for such synchronization reference path is assumed known here. As described earlier and as seen in FIG. 12, reflections from objects arriving at or close in time (which depends on bandwidth and receiver resolution) and in the spatial direction of the reference path might not be distinguishable from reflections coming from the synchronization reference path.

Having two passive regular reflectors in the scenarios shown in FIG. 12 would likely not work to solve the issue of resolving objects being close to a synchronization paths reflection point. As an example, using NLOS2 instead of using NLOS1 (where the paths separated in time T_{NLOS1}≠T_{NLOS2}) for detecting object “A” may still result in reflections from NLOS1 occurring when illuminating object “A” and vice versa for detecting object “B”. By using NLOS1, reflections from NLOS2 will still be present and interfere with reflections from object B.

Instead, a method using Reconfigurable Intelligent Surfaces (RIS 35) is disclosed for the synchronization paths. The method includes re-configuring the RIS 35 at occasions to detect or track objects close to the RIS 35, and the possibility to change the characteristics of the synchronization reference path. For example, the method may include one or both of:
For object “A,” disabling the RIS 1 reflected synchronization reference path to the bistatic receiver and enabling an alternative synchronization path by either using another RIS 35 (RIS2) or creating an alternative path from RIS 1, e.g., through a passive reflector;
Changing the delay for synchronization path through the RIS 35 by a known amount; and
Changing reference path angle and/or delay for a new synchronization reference path.

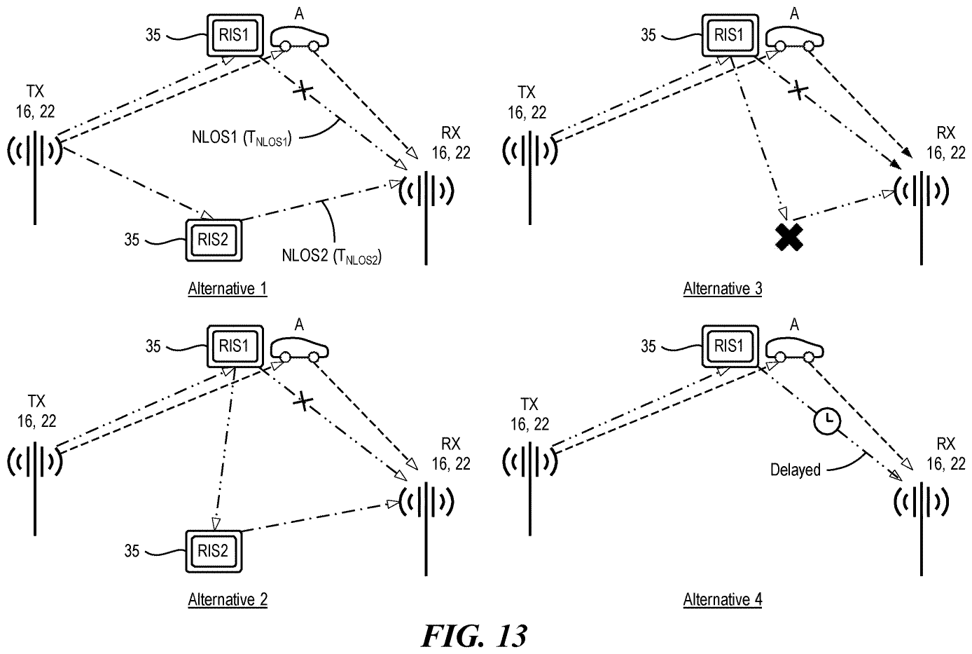

In the examples shown in FIG. 13, the available configuration options may be known for the TX and RX nodes as well as the specific characteristics for each of the available synchronization paths. Such characteristics may include the direction and ToF (T_{ref_path}), either through known location of the nodes in the path or through pre-characterization, e.g., through over-the-air RTT measurements. The alternative synchronization paths to the receiver may have different channel properties (dependent on bi-static system time resolution and spatial resolution) in either time (T_{ref_path}) or directivity (AoA) or both for detecting objects close to a synchronization path reflection point.

To detect objects in the environment, the TX and RX nodes will perform bi-static radar scan of the surrounding environment on a regular basis as shown in FIG. 12. FIG. 12 includes an example for changing reference path to avoid issues detecting objects close to the reference path reflection. The switching period and pattern may be set based on maximum allowed delay for detecting such objects during a radar scan.

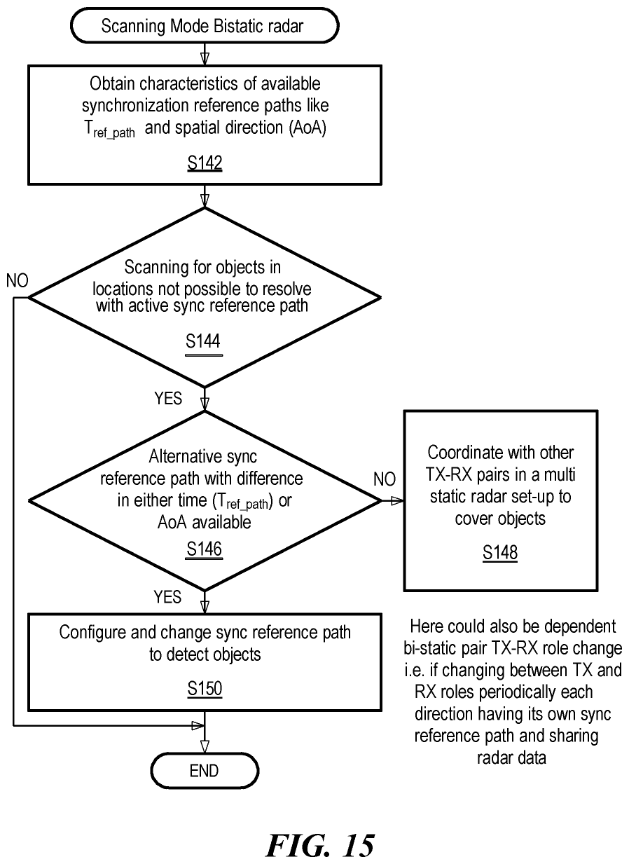

An example process of a scanning mode of a bistatic radar is shown in FIG. 15. In a first step, characteristics of available synchronization reference paths are obtained (Block S142). If scanning with an active synchronization reference path does not result in a resolvable object (Block S144), an alternate synchronization reference path is tried (Block S146). If no alternate synchronization reference path resulting in a resolvable object is found, then the scanning device (i.e., network node 16 or WD 22), coordinates with other transmit-receive pairs to track the object (Block S148). Once a synchronization reference path is found that enables object resolution, the scanning device is configured to use that synchronization reference path to detect objects (Block S150).

When the bi-static radar operates in tracking mode, i.e., when it tracks objects already detected at regular intervals, the bi-static radar knows the direction (AoA) and ToF (T_{object}) for the object-reflected path and may use this information to select a most appropriate synchronization reference path. In some cases, the path may be selected based on any of ToA or ToF, when one or the other is not available. In a tracking scenario for moving objects, it will be known when a tracked object has changed to a position where there is a need to switch synchronization reference paths. In this event, allowing a change in reference path characteristics prior to such event and making sure objects may still be separated considering system range resolution, and spatial resolution may occur. The selection of reference path for a tracked object may also be based on prediction of an object's future position by velocity estimates and have a hysteresis to avoid too frequent switching.

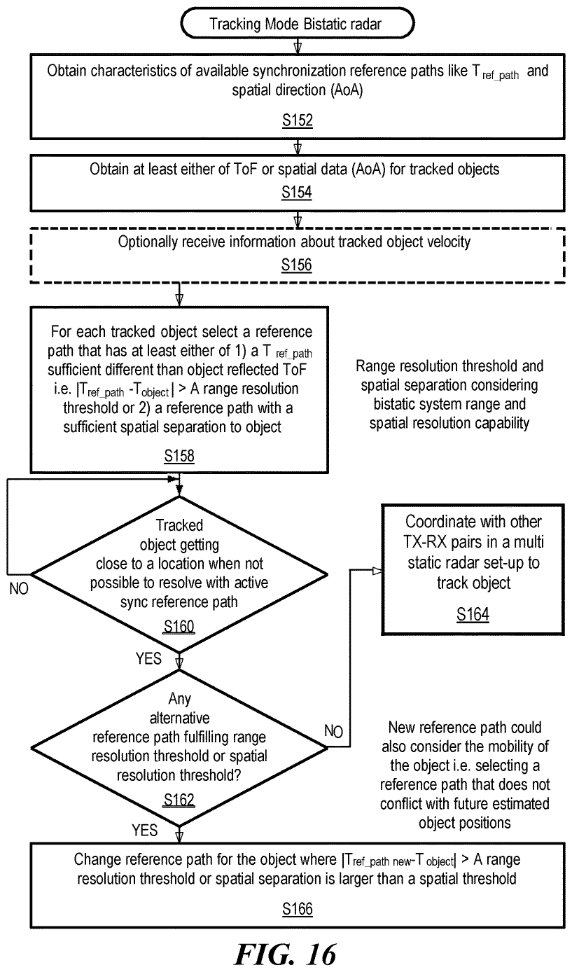

An example process of a tracking mode of a bistatic radar is shown in FIG. 16. In a first step, characteristics of available synchronization reference paths are obtained (Block S142). A ToF or spatial data is obtained for each tracked object (Block S154). Optionally, the tracking device (network node 16 or WD 22) may obtain tracked object velocity information (Block S156). For each tracked object, a synchronization reference path is selected that is resolvable from the object (Block S158). When a tracked object gets close to being unresolvable with the synchronization reference path (Block S160), then an alternative path is searched (Block S162). If no alternative path is found, then the scanning device (i.e., network node 16 or WD 22) coordinates with other transmit-receive pairs to track the object (Block S164). Once a synchronization reference path is found that enables object resolution, the scanning device is configured to use that synchronization reference path to detect objects (Block S166).

A bi-static radar operation may regularly change the role of TX and RX nodes (i.e., at certain times one of the nodes in the pair acts as TX and the other acts as RX and at another time the roles are the opposite) and the TX and RX may share radar information with each other. The reference paths used may change as the roles change and hence, each receiver may use the same reference path and sensing limitations in a certain bi-static sensing direction that may not be present in the another direction when the different directions use different synchronization paths. As used hereafter, the TX and the RX may be a network node 16 and/or a wireless device 22.

The RIS 35 may be controlled and configured by either the TX, RX, or a central node and as for earlier described bi-static TX-RX roles, the change may depend on the direction of the reference path.

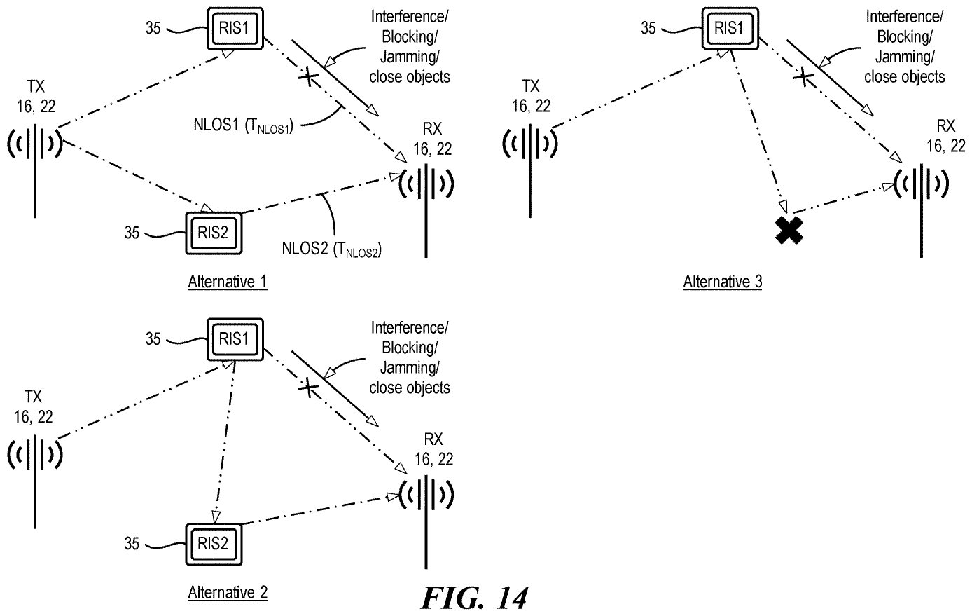

The synchronization path may be blocked by objects in the environment and/or be subject to unintentional or intentional interference. Similar to the issue of detecting and distinguishing objects close to the synchronization reference path's NLOS reflection point, reflections from such objects may also impact the receiver's ability to distinguish and accurately resolve the synchronization reference. This may create an uncertainty in its reception time and thereby degrade the radar sensing for all objects. Therefore, the RIS 35 shown in FIGS. 4 and 5, used as illustrated in FIGS. 13 and 14 may be used to increase the robustness and performance of the synchronization path. The receiver may regularly monitor the quality of the reference path alternatives created by the RIS 35 and select the most appropriate reference path. Monitoring may also include checking relative arrival times between different paths and thereby detect a spoofing attempt to manipulate the arrival time of one of the synchronization paths. Thus, in some embodiments, a synchronization reference path is selected to avoid jamming and/or interference.

Some embodiments may include one or more of the following:
Embodiment A1. A network node configured to communicate with a wireless device (WD), the network node configured to, and/or comprising a radio interface and/or comprising processing circuitry configured to:
   use a first synchronization reference path via a first reconfigurable intelligent surface (RIS) to scan for an object not resolvable in one of distance, time and angle from a location of a second RIS; and
   when an object not resolvable from the location of the second RIS is detected, select the first synchronization reference path for a subsequent detection of the object.
Embodiment A2. The network node of Embodiment A1, wherein the processing circuitry is further configured to track the object using the first synchronization reference path.
Embodiment A3. The network node of any of Embodiments A1 and A2, wherein the processing circuitry is further configured to switch between the first synchronization reference path via the first RIS and a second synchronization reference path via a second RIS.
Embodiment A4. The network node of Embodiment A3, wherein the switching occurs according to a pattern based at least in part on an allowable delay for detecting an object during a radar scan.
Embodiment A5. The network node of any of Embodiments A3 and A4, wherein the second synchronization reference path is selected based at least in part on at least one of a time of arrival (ToA) and a time of flight (ToF).
Embodiment A6. The network node of any of Embodiments A3-A5, wherein a decision to switch between the first and second synchronization reference path is based at least in part on a prediction of a future position of the object.
Embodiment A7. The network node of any of Embodiments A1-A6, wherein the processing circuitry is further configured to monitor multiple synchronization reference paths and select a reference path based on resolvability of the object for each synchronization reference path.
Embodiment A8. The network node of Embodiment 7, wherein the processing circuitry is further configured to monitor arrival times for each of a plurality of synchronization reference paths to defeat spoofing.
Embodiment A9. The network node of any of Embodiments A1-A8, wherein the network node is one of a wireless device (WD) and a radio base station.
Embodiment B1. A method implemented in a network node, the network node being one a wireless device (WD) and a radio base station, the method comprising:
   using a first synchronization reference path via a first reconfigurable intelligent surface (RIS) to scan for an object not resolvable in one of distance, time and angle from a location of a second RIS; and
   when an object not resolvable from the location of the second RIS is detected, selecting the first synchronization reference path for a subsequent detection of the object.
Embodiment B2. The method of Embodiment A1, further comprising tracking the object using the first synchronization reference path.
Embodiment B3. The method of any of Embodiments A1 and A2, further comprising switching between the first synchronization reference path via the first RIS and a second synchronization reference path via a second RIS.
Embodiment B4. The method of Embodiment A3, wherein the switching occurs according to a pattern based at least in part on an allowable delay for detecting an object during a radar scan.
Embodiment B5. The method of any of Embodiments A3 and A4, wherein the second synchronization reference path is selected based at least in part on at least one of a time of arrival (ToA) and a time of flight (ToF).
Embodiment B6. The method of any of Embodiments A3-A5, wherein a decision to switch between the first and second synchronization reference path is based at least in part on a prediction of a future position of the object.
Embodiment B7. The method of any of Embodiments A1-A6, further comprising monitoring multiple synchronization reference paths and selecting a reference path based on resolvability of the object for each synchronization reference path.
Embodiment B8. The method of Embodiment 7, further comprising monitoring arrival times for each a plurality of synchronization reference paths to defeat spoofing.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-20. (canceled)

21. A first network node configured to communicate with a second network node via a radio frequency channel, the first network node comprising processing circuitry configured to:
select a first synchronization reference path for synchronization between the first network node and the second network node via a first reconfigurable repeater, wherein the first synchronization reference path is selected to be resolvable from the following: a second synchronization path that includes a second reconfigurable repeater, and an object; and
upon occurrence of interference or jamming in the first synchronization reference path, use the second synchronization reference path via the second reconfigurable reference path for synchronization between the first network node and the second network node.

22. The first network node of claim 21, wherein the processing circuitry is configured to detect and track an object using the first synchronization reference path.

23. The first network node of claim 21, wherein the processing circuitry is configured to switch between the first and second synchronization reference paths according to a pattern based on an allowable delay for detecting the object during a radar scan.

24. The first network node of claim 23, wherein the processing circuitry is configured to switch between the first and second synchronization reference paths further based on a prediction of a future position of the object.

25. The first network node of claim 21, wherein one of the first and second synchronization reference paths is selected based on at least one of the following: a time of arrival (ToA), and a time of flight (ToF).

26. The first network node of claim 21, wherein the processing circuitry is further configured to:
monitor multiple synchronization reference paths, including the first and second synchronization reference paths; and
select one of the monitored synchronization reference paths based on resolvability of the object for each of the monitored synchronization reference paths.

27. The first network node of claim 21, wherein the processing circuitry is further configured to monitor arrival times for each of the first and second synchronization reference paths to defeat spoofing.

28. The first network node of claim 21, wherein at least one of the first synchronization reference path and the second synchronization reference path includes a passive reflector.

29. The first network node of claim 21, wherein the processing circuitry is configured to use the second synchronization reference path based on changing a reference path angle or a delay for the second synchronization reference path.

30. The first network node of claim 21, wherein:
the first network node is a wireless device (WD) or a radio base station, and
the second network node is a WD or a radio base station.

31. A method performed by a first network node configured to communicate with a second network node, the method comprising:
selecting a first synchronization reference path for synchronization between the first network node and the second network node via a first reconfigurable repeater, wherein the first synchronization reference path is selected to be resolvable from the following: a second synchronization path that includes a second reconfigurable repeater, and an object; and
upon occurrence of interference or jamming in the first synchronization reference path, using the second synchronization reference path via the second reconfigurable reference path for synchronization between the first network node and the second network node.

32. The method of claim 31, further comprising detecting tracking an object using the first synchronization reference path.

33. The method of claim 31, further comprising switching between the first and second synchronization reference paths according to a pattern based on an allowable delay for detecting the object during a radar scan.

34. The method of claim 33, wherein switching between the first and second synchronization reference paths is further based on a prediction of a future position of the object.

35. The method of claim 31, wherein one of the first and second synchronization reference paths is selected based on at least one of the following: a time of arrival (ToA), and a time of flight (ToF).

36. The method of claim 31, further comprising:
monitoring multiple synchronization reference paths, including the first and second synchronization reference paths; and
selecting one of the monitored synchronization reference paths based on resolvability of the object for each of the monitored synchronization reference paths.

37. The method of claim 31, further comprising monitoring arrival times for each of the first and second synchronization reference paths to defeat spoofing.

38. The method of claim 31, wherein at least one of the first synchronization reference path and the second synchronization reference path includes a passive reflector.

39. The method of claim 31, wherein using the second synchronization reference path comprises changing a reference path angle or delay for the second synchronization reference path.

40. The method of claim 31, wherein:
the first network node is a wireless device (WD) or a radio base station, and
the second network node is a WD or a radio base station.
